(19) United States
(12) Patent Application Publication
(10) Pub. No.: US 2019/0073587 A1
(43) Pub. Date: Mar. 7, 2019

(54) LEARNING DEVICE, INFORMATION PROCESSING DEVICE, LEARNING METHOD, AND COMPUTER PROGRAM PRODUCT

(71) Applicant: Kabushiki Kaisha Toshiba, Tokyo (JP)

(72) Inventors: Kentaro TAKAGI, Kawasaki Kanagawa (JP); Kouta NAKATA, Shinagawa Tokyo (JP)

(21) Appl. No.: 15/899,599

(22) Filed: Feb. 20, 2018

(30) Foreign Application Priority Data
Sep. 4, 2017 (JP) 2017-169448

(51) Int. Cl. G06N 3/08; G06N 3/04

(52) U.S. Cl. CPC G06N 3/08; G06N 3/04

(57) ABSTRACT

According to an embodiment, a learning device includes a calculator and a learner. The calculator is configured to calculate a value of a first objective function and a value of a second objective function. The first objective function includes smoothness that indicates smoothness of a local distribution of an output of a model, and is used to estimate a first model parameter for determining the model. The second objective function is used to estimate, with a second model parameter that is a hyperparameter of a learning method of learning, the model by using the first objective function. The second model parameter to be estimated is closer to a distance scale of learning data. The learner is configured to update the first model parameter and the second model parameter so that the value of the first objective function and the value of the second objective function are optimized.

### CROSS-REFERENCE TO RELATED APPLICATIONS

This application is based upon and claims the benefit of priority from Japanese Patent Application No. 2017-169448, filed on Sep. 4, 2017; the entire contents of which are incorporated herein by reference.

### FIELD

Embodiments described herein relate generally to a learning device, an information processing device, a learning method, and a computer program product.

### BACKGROUND

With respect to machine learning, a technology of automatically tuning a hyperparameter of a model, and a technology of adding a regularization term to an objective function are proposed to learn a highly-accurate classifier or regression.

However, there is a problem in a conventional technology that a calculation cost to determine a hyperparameter is high.

### BRIEF DESCRIPTION OF THE DRAWINGS

FIG. 1 is a block diagram of an information processing device including a learning device according to a first embodiment;

FIG. 2 is a flowchart of learning processing in the first embodiment;

FIG. 3 is a flowchart of calculation processing by a calculator;

FIG. 4 is a block diagram of an information processing device including a learning device according to a second embodiment;

FIG. 5 is a flowchart of calculation processing in the second embodiment;

FIG. 6 is a block diagram of an information processing device including a learning device according to a third embodiment; and

FIG. 7 is a hardware configuration of a device according to the first to third embodiments.

### DETAILED DESCRIPTION

According to an embodiment, a learning device includes a calculator and a learner. The calculator is configured to calculate a value of a first objective function and a value of a second objective function. The first objective function includes smoothness that indicates smoothness of a local distribution of an output of a model, and is used to estimate a first model parameter for determining the model. The second objective function is used to estimate, with a second model parameter that is a hyperparameter of a learning method of learning, the model by using the first objective function. The second model parameter to be estimated is closer to a distance scale of learning data. The learner is configured to update the first model parameter and the second model parameter so that the value of the first objective function and the value of the second objective function are optimized.

In the following, preferable embodiments of a learning device according to the present invention will be described in detail with reference to the attached drawings.

A settable range of a hyperparameter is wide, and there is a case where an influence thereof on accuracy is significant. Thus, a hyperparameter is conventionally determined, for example, by a grid search and Bayesian optimization. In such methods, learning is executed for a plurality of times and an optimal hyperparameter is determined according to a result thereof. Thus, a calculation cost to determine a hyperparameter becomes high.

In each of the following embodiments, an objective function with respect to a hyperparameter is introduced and learning of a hyperparameter is performed simultaneously with learning of a model. Accordingly, it becomes unnecessary to manually set a hyperparameter. Also, for example, since a hyperparameter can be learned simultaneously in one-time learning of a model, a calculation cost to determine a hyperparameter can be decreased. Also, it becomes possible to learn more accurate model.

The present embodiments described in the following will be described with a case where a model is learned by a virtual adversarial training (VAT) method with utilization of a neutral network as a machine learning model being an example. An applicable model is not limited to a neutral network. Also, an applicable learning method is not limited to a VAT method. For example, a different learning method such as gradient boosting may be used. For example, a support vector machine (SVM) or the like may be used.

### First Embodiment

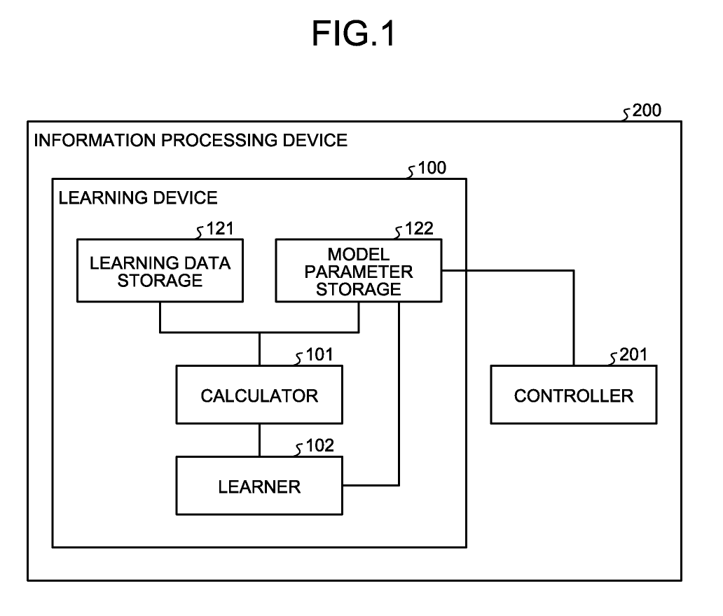

FIG. 1 is a block diagram illustrating an example of a configuration of an information processing device 200 including a learning device 100 according to the first embodiment. The information processing device 200 is an example of a device that executes information processing using a model learned by the learning device 100. The information processing can be any kind of processing as long as the processing uses a model. For example, the information processing may be recognition processing such as speech recognition, image recognition, and character recognition using a model. Also, the information processing may be prediction processing such as prediction of abnormality of a device, and prediction of a value of a sensor (such as room temperature).

As illustrated in FIG. 1, the information processing device 200 includes the learning device 100 and a controller 201. The learning device 100 includes a learning data storage 121, a model parameter storage 122, a calculator 101, and a learner 102.

The learning data storage 121 stores a previously-prepared data set used as learning data of machine learning. The data set includes N pieces of (N is integer number equal to or larger than 1) input data xⁱ (i=1, 2, . . . , and N), and output yⁱ (i=1, 2, . . . , and N) with respect to the input data. For example, in a case where a classification problem of an image is considered, x is an image, and y is a classification label with respect to the image.

The model parameter storage 122 stores a model parameter ϕ estimated by learning of a machine learning model. For example, in a case of a neutral network, the model parameter ϕ is a weight, a bias, and the like. For example, a three-layer neutral network F(x) is expressed by the following Equation (1) by utilization of a weight w⁽¹⁾, and a bias b⁽¹⁾ of an l-layer. Here, a⁽¹⁾ indicates an activating function of the l-layer.

F(x)=a⁽³⁾(w⁽³⁾a⁽²⁾(w⁽²⁾a⁽²⁾(w⁽¹⁾x+b⁽¹⁾)+b⁽²⁾)+b⁽³⁾) (1)

A model parameter of this case is {w⁽¹⁾, b⁽¹⁾; l=1, 2, 3}. That is, the model parameter ϕ is expressed by the following Equation (2).

ϕ={w⁽¹⁾,b⁽¹⁾;l=1,2,3} (2)

In the first embodiment, a hyperparameter ε to control a learning behavior of VAT is estimated by learning. Thus, the model parameter storage 122 further stores the hyperparameter ε as a model parameter. Thus, a model parameter of the present embodiment becomes {ϕ, ε}. Note that ϕ of this case is expressed by Equation (2).

Note that in VAT, smoothness indicating smoothness of a local distribution of a model output is added as a regularization term. The hyperparameter ε is a hyperparameter to calculate smoothness. More specifically, the hyperparameter ε is a hyperparameter indicating an upper limit of perturbation in calculation of smoothness. A detail of VAT will be described later.

Initial values of the model parameters ϕ and ε stored in the model parameter storage 122 are initialized by a general initialization method with respect to a parameter of a neutral network. For example, a model parameter is initialized by a constant value, a normal distribution, a uniform distribution, and the like.

The calculator 101 calculates a value (output value) of an objective function used in learning. In the present embodiment, the calculator 101 calculates a value of an objective function to estimate a hyperparameter as a model parameter (second objective function) in addition to a value of an objective function used in VAT (first objective function).

The first objective function is an objective function that includes smoothness indicating smoothness of a local distribution of an output of a model and that is to estimate a model parameter determining a model (first model parameter). The second objective function is an objective function in which a hyperparameter ε of VAT (learning method of learning model by using first objective function) is a model parameter (second model parameter). Also, the second objective function is an objective function to estimate a second model parameter closer to a distance scale of learning data.

The learner 102 learns a model (neutral network) by using learning data and updates a model parameter. For example, the learner 102 learns and updates the first model parameter and the second model parameter in such a manner as to optimize a value of the first objective function and a value of the second objective function.

The controller 201 controls information processing using a learned model. For example, the controller 201 controls information processing using a model (neutral network) determined by an updated first model parameter.

The above units (calculator 101, learner 102, and controller 201) are realized, for example, by one or a plurality of processors. For example, the above units may be realized by causing a processor such as a central processing unit (CPU) to execute a program, that is, by software. The above units may be realized by a processor such as a special integrated circuit (IC), that is, by hardware. The above units may be realized by utilization of software and hardware in combination. In a case where a plurality of processors is used, each processor may realize one of the units or two or more of the units.

The learning data storage 121 and the model parameter storage 122 can include any kinds of generally-used storage media such as a hard disk drive (HDD), an optical disk, a memory card, and a random access memory (RAM). The storages may be physically-different storage media or may be realized as different storage regions of the physically same storage medium. Moreover, the storages may be realized by a plurality of physically-different storage media.

The information processing device 200 may be realized, for example, by a server device including a processor such as a CPU. The controller 201 of the information processing device 200 may be realized by software using a CPU or the like, and the learning device 100 thereof may be realized by a hardware circuit. The whole information processing device 200 may be realized by a hardware circuit.

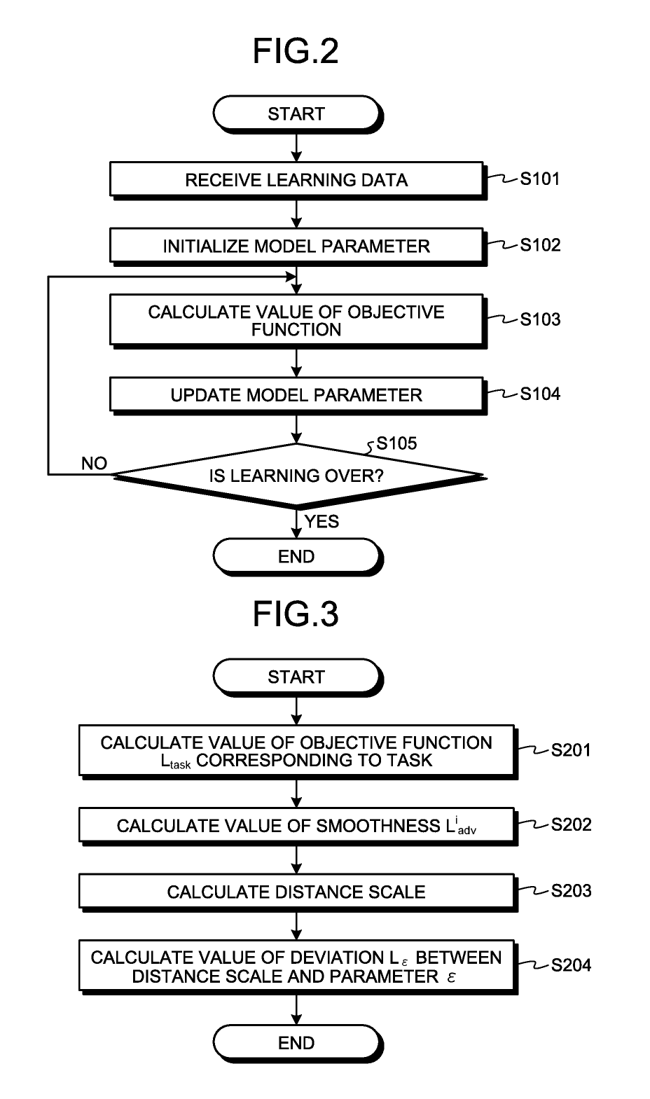

Next, learning processing by the learning device 100 according to the first embodiment configured in such a manner will be described with reference to FIG. 2. FIG. 2 is a flowchart illustrating an example of learning processing in the first embodiment.

The learning device 100 receives learning data and stores the data into the learning data storage 121 (Step S101). Also, the learning device 100 stores a model parameter, in which an initial value is set, into the model parameter storage 122 (Step S102).

The calculator 101 calculates a value of an objective function by using the stored model parameter and learning data (Step S103). FIG. 3 is a flowchart illustrating an example of calculation processing by the calculator 101.

The calculator 101 calculates a value of an objective function Lₜₐₛₖ corresponding to a task of machine learning (Step S201). For example, in a case where the task of the machine learning is a multi-class classification problem, the calculator 101 calculates cross entropy as a value of the objective function Lₜₐₛₖ.

Next, the calculator 101 calculates smoothness Lⁱ_{adv} indicating smoothness of a local distribution of a model output that is a regularization term added in VAT (Step S202). The smoothness Lⁱ_{adv} is calculated, for example, by the following Equations (3) to (5).

$$\begin{matrix}Δ ( {r}^{i} ) = KL [ f ( {x}^{i} ) \vert \vert f ( {x}^{i} + {r}^{i} ) ] & ( 3 ) \\ {r}_{a}^{i} = {argmax}_{{r}^{i} \text{:} \vert \vert {r}^{i} \vert \vert < ɛ} \{ Δ ( {r}^{i} ) \} & ( 4 ) \\ {L}_{adv}^{i} = Δ ( {r}_{a}^{i} ) & ( 5 )\end{matrix}$$

f(xⁱ) is an output of a neutral network. In a case where VAT is used, an output L(ϕ) of the calculator 101 is expressed by the following Equation (6).

$$L ( φ ) = {L}_{task} + {\sum }_{i} {L}_{adv}^{i} \qquad ( 6 )$$

The value of the objective function Lₜₐₛₖ and the smoothness Lⁱ_{adv} that are respectively calculated in Step S201 and Step S202 correspond to an objective function used in VAT (first objective function).

As described above, in the present embodiment, the calculator 101 further calculates a value of an objective function to estimate a hyperparameter ε as a model parameter (second objective function). For example, the calculator 101 first calculates a distance scale l_{g} by the following Equation (7) (Step S203).

$${I}_{g} = 〈 {min}_{j} \vert \vert {x}^{i} - {x}^{j} \vert \vert 〉 \qquad ( 7 )$$

where x^{j} indicates input data other than xⁱ (second learning data). min indicates a minimum value of a distance to each piece of x^{j} which distance is calculated for each piece of input data xⁱ (first learning data). A symbol “< >” indicates an average of minimum values calculated for pieces of xⁱ. The data x^{j} may be all pieces of input data other than xⁱ or may be a part of the data. For example, in a case where an update in the learner 102 is performed in a unit of a mini batch, data other than xⁱ among pieces of data of the mini batch may be x^{j}. In such a manner, the distance scale l_{g} is calculated on the basis of a minimum value of a distance between each input data (xⁱ) and an adjacent point (x^{j}).

The calculator 101 calculates an objective function L_{ε} with respect to the hyperparameter ε by the following Equation (8) in such a manner that a value of the distance scale l_{g} and a value of the hyperparameter ε become close to each other (Step S204). The value of the objective function L_{ε} corresponds to a deviation between the distance scale l_{g} and the hyperparameter ε.

L_{ε}=∥l_{g}−ε∥ (8)

An output L(ϕ, ε) of the calculator 101 is expressed by the following Equation (9).

$$L ( φ , ɛ ) = {L}_{task} + {L}_{ɛ} + {\sum }_{i} {L}_{adv}^{i} \qquad ( 9 )$$

The calculator 101 calculates an output value of L(ϕ, ε) in Equation (9), outputs the value as a value of the objective function, and ends the calculation processing.

Referring back to FIG. 2, the learner 102 updates a model parameter by using a value of the calculated objective function (Step S104). For example, the learner 102 updates the model parameter by using a stochastic gradient descent or the like in such a manner that a value of the objective function L(ϕ, ε) becomes small. A detailed Equation of an update of a case where the stochastic gradient descent is used is expressed by the following Equations (10) and (11). Here, γ indicates a learning rate of the stochastic gradient descent and indexes t and t−1 respectively indicate post-update and pre-update.

ϕ^{t}=ϕ^{t-1}−γ∇_{ϕ}L(ϕ^{t-1},ε^{t-1}) (10)

ε^{t}=ε^{t-1}−γ∇_{ε}L(ϕ^{t-1},ε^{t-1}) (11)

The learner 102 stores the updated model parameter into the model parameter storage 122, for example. The learner 102 may output the updated model parameter to a configuration unit other than the model parameter storage 122, such as an external device that executes processing using a model.

Subsequently, the learner 102 determines whether to end the update (whether to end learning) (Step S105). Whether to end the update is determined, for example, depending on whether a value of the model parameter converges.

In a case where the update is kept performed (Step S105: No), the processing is brought back to Step S103 and repeatedly performed. In a case where the update is ended (Step S105: Yes), the learner 102 outputs the model parameters ϕ and ε, and ends the learning processing.

In such a manner, according to the first embodiment, it becomes unnecessary for a user to manually determine a value of an appropriate hyperparameter (such as ε) and it becomes possible to stably learn an accurate model.

### Second Embodiment

In the first embodiment, the smoothness indicates smoothness of an output of a model with respect to a change in an input data space. On the other hand, it is known that a projective space (such as output of interlayer in case of neutral network) has a spatially better property than the input data space. In the second embodiment, smoothness is calculated as smoothness of a model output with respect to a change in a projective space.

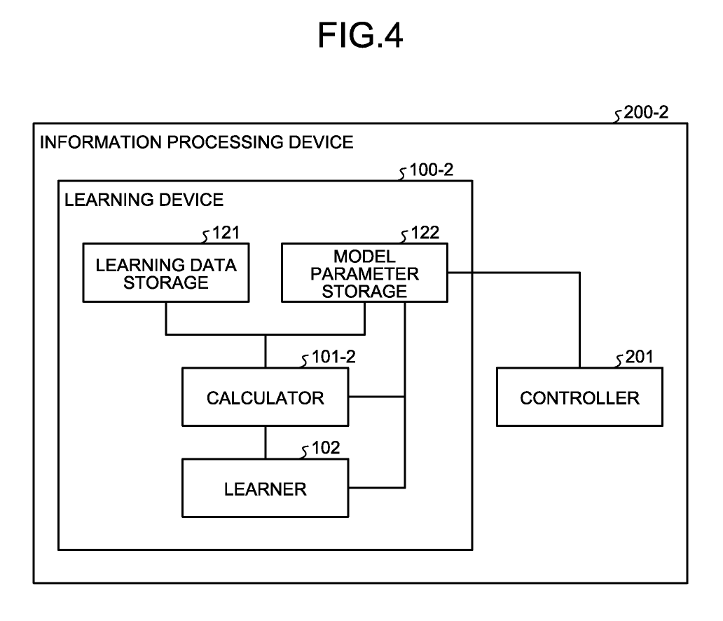

FIG. 4 is a block diagram illustrating an example of a configuration of an information processing device 200-2 including a learning device 100-2 according to the second embodiment. As illustrated in FIG. 4, the information processing device 200-2 includes the learning device 100-2, and a controller 201. The learning device 100-2 includes a learning data storage 121, a model parameter storage 122, a calculator 101-2, and a learner 102.

In the second embodiment, a function of the calculator 101-2 is different from that of the first embodiment. Since the other configuration and function are similar to those in FIG. 1 that is a block diagram of the learning device 100 according to the first embodiment, the same sign is assigned thereto and a description thereof is omitted here.

The calculator 101-2 is different from the calculator 101 of the first embodiment in a point that smoothness of input data in a projective space is calculated. The calculator 101-2 calculates smoothness Lⁱ_{adv}, for example, by the following Equations (12) to (14).

$$\begin{matrix}Δ ( {r}^{i} ) = KL [ f ( g ( {x}^{i} ) ) \vert \vert f ( g ( {x}^{i} ) + {r}^{i} ) ] & ( 12 ) \\ {r}_{a}^{i} = {argmax}_{{r}^{i} \text{:} \vert \vert {r}^{i} \vert \vert < ɛ} \{ Δ ( {r}^{i} ) \} & ( 13 ) \\ {L}_{adv}^{i} = Δ ( {r}_{a}^{i} ) & ( 14 )\end{matrix}$$

Here, g(xⁱ) is an output of an interlayer (such as last interlayer) of a neutral network, and f(g(xⁱ)) is an output of a neutral network.

The output g(xⁱ) is not limited to the output of the interlayer of the neutral network and may be any kind of mapping. For example, g(xⁱ) may be mapping of a principal component analysis. Also, in a case of the output of the interlayer of the neutral network, there may be one or a plurality of interlayers. For example, the sum of outputs of a plurality of interlayers, and the weighted sum of outputs of a plurality of interlayers may be used as g(xⁱ).

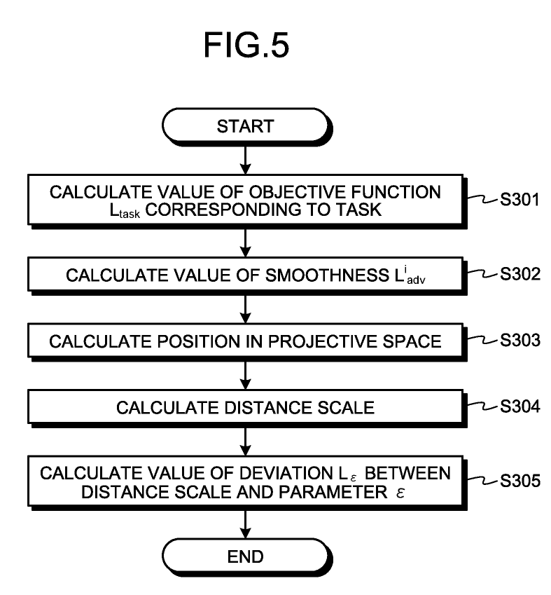

Next, calculation processing by the calculator 101-2 of the learning device 100-2 according to the second embodiment configured in such a manner will be described with reference to FIG. 5. FIG. 5 is a flowchart illustrating an example of calculation processing in the second embodiment. Note that since a flow of whole learning processing by the learner 102 is similar to that in FIG. 2 illustrating the learning processing of the first embodiment, a description thereof is omitted.

Since Step S301 and Step S302 are processing similar to Step S201 and Step S202 in the learning device 100 according to the first embodiment, a description thereof is omitted.

The calculator 101-2 of the second embodiment calculates a position g(xⁱ) of input data xⁱ in a projective space (Step S303) before calculation of a distance scale (Step S304). Then, the calculator 101-2 calculates a distance scale l_{g} between input data xⁱ and an adjacent point x^{j} in the projective space by the following Equation (15) (Step S304).

$${I}_{g} = 〈 {min}_{j} \vert \vert g ( {x}^{i} ) - g ( {x}^{j} ) \vert \vert 〉 \qquad ( 15 )$$

The learner 102 calculates an objective function L_{ε} with respect to a hyperparameter ε by the above-described Equation (8) in such a manner that the distance scale l_{g} and the hyperparameter ε become close to each other (Step S305).

According to the second embodiment, even in a case where a neighborhood distance of a data point in the projective space is unknown, it is possible to learn an accurate model without manual setting of the hyperparameter ε by a user.

### Third Embodiment

In each of the first and second embodiments, an appropriate hyperparameter ε is learned with respect to all pieces of learning data. On the other hand, in a case where density of learning data is different, it is predicted that a neighborhood distance varies greatly depending on a data point. Thus, a hyperparameter εᵢ determined for each data point is used in the third embodiment.

Note that in the following, an example in which the second embodiment is modified in such a manner that a hyperparameter for each data point is used will be described. A similar modification can be also applied to the first embodiment.

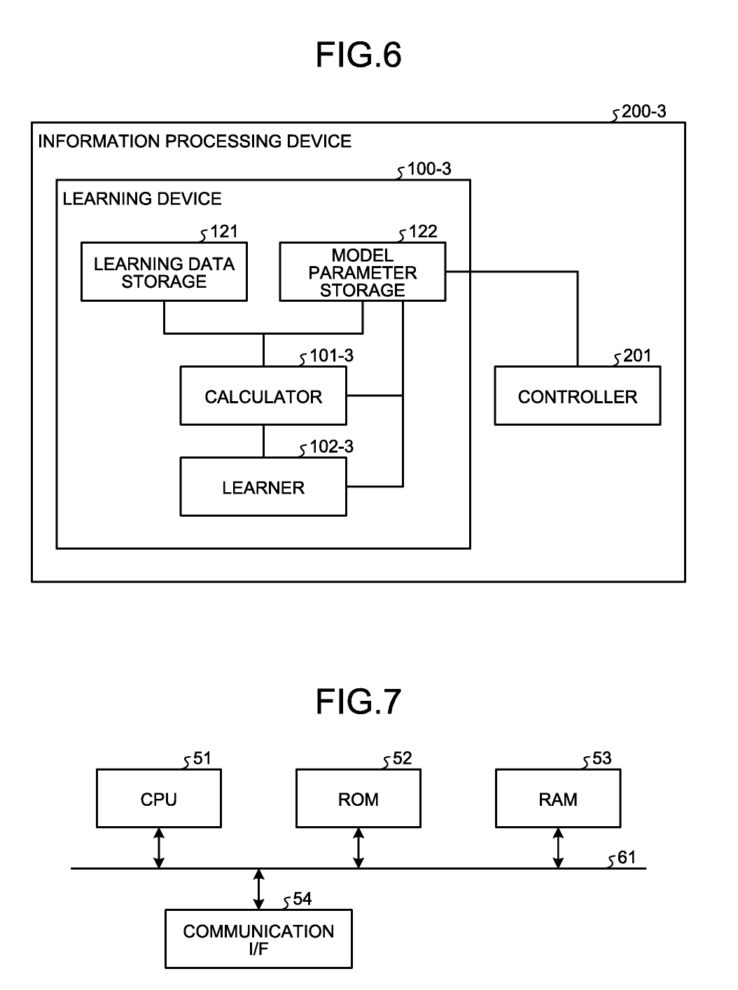

FIG. 6 is a block diagram illustrating an example of a configuration of an information processing device 200-3 including a learning device 100-3 according to the third embodiment. As illustrated in FIG. 6, the information processing device 200-3 includes the learning device 100-3 and a controller 201. The learning device 100-3 includes a learning data storage 121, a model parameter storage 122, a calculator 101-3, and a learner 102-3.

In the third embodiment, functions of the calculator 101-3 and the learner 102-3 are different from those of the second embodiment. Since the other configuration and function are similar to those in FIG. 4 that is a block diagram of the learning device 100-2 according to the second embodiment, the same sign is assigned thereto and a description thereof is omitted here.

The calculator 101-3 is different from the calculator 101-2 of the second embodiment in a point that smoothness Lⁱ_{adv} is calculated by the following Equations (16) to (18).

$$\begin{matrix}Δ ( {r}^{i} ) = KL [ f ( g ( {x}^{i} ) ) \vert \vert f ( g ( {x}^{i} ) + {r}^{i} ) ] & ( 16 ) \\ {r}_{a}^{i} = {argmax}_{{r}^{i} \text{:} \vert \vert {r}^{i} \vert \vert < {ɛ}_{i}} \{ Δ ( {r}^{i} ) \} & ( 17 ) \\ {L}_{adv}^{i} = Δ ( {r}_{a}^{i} ) & ( 18 )\end{matrix}$$

With calculation in such a manner, rⁱₐ varies depending on a data point in the present embodiment. The calculator 101-3 calculates a value of an objective function with respect to a hyperparameter εᵢ by the following procedure. First, the calculator 101-3 calculates a position g(xⁱ) of each data point in a projective space. The calculator 101-3 calculates a distance scale lⁱ_{g} of each data point with respect to an adjacent point by the following Equation (19).

$${I}_{g}^{i} = {min}_{j} \vert \vert g ( {x}^{i} ) - g ( {x}^{j} ) \vert \vert \qquad ( 19 )$$

The calculator 101-3 calculates a value of an objective function Lⁱ_{ε} with respect to the hyperparameter εᵢ by the following Equation (20).

L_{ε}ⁱ=∥l_{g}ⁱ−εᵢ∥ (20)

An output L(ϕ, ε) of the calculator 101-3 is expressed by the following Equation (21) in the third embodiment.

$$L ( φ , ɛ ) = {L}_{task} + {\sum }_{i} ( {L}_{ɛ}^{i} + {L}_{adv}^{i} ) \qquad ( 21 )$$

The learner 102-3 updates a model parameter by using a stochastic gradient descent or the like in such a manner that a value of the objective function L(ϕ, ε) becomes small. A detailed Equation of an update of a case where the stochastic gradient descent is used is expressed by the following Equations (22) and (23).

ϕ^{t}=ϕ^{t-1}−γ∇_{ϕ}L(ϕ^{t-1},ε^{t-1}) (22)

ε^{t-1}=εᵢ^{t-1}−γ∇_{ε}_{ᵢ}L(ϕ^{t-1},ε^{t-1}) (23)

Note that since a flow of whole learning processing by the learner 102-3, and a flow of whole calculation processing by the calculator 101-3 are respectively similar to that in FIG. 2 illustrating the learning processing of the first embodiment, and that in FIG. 5 illustrating the calculation processing of the second embodiment.

According to the third embodiment, even in a case where an appropriate neighborhood distance varies depending on a piece of data, such as a case where data is locally gathered, it is possible to learn an accurate model without manual setting of a hyperparameter by a user.

As described above, according to the first to third embodiments, it becomes possible to decrease a calculation cost to determine a hyperparameter.

Next, a hardware configuration of a device according to each of the first to third embodiments (information processing device and learning device) will be described with reference to FIG. 7. FIG. 7 is a view for describing a hardware configuration example of a device according to each of the first to third embodiments.

The device according to each of the first to third embodiments includes a control device such as a CPU 51, a storage device such as a read only memory (ROM) 52 or a RAM 53, a communication I/F 54 that is connected to a network and performs communication, and a bus 61 that connects the units.

A program executed in the device according to each of the first to third embodiments is previously installed in the ROM 52 or the like and provided.

A program executed in the device according to each of the first to third embodiments may be recorded, in a file of an installable format or an executable format, into a computer-readable recording medium such as a compact disk read only memory (CD-ROM), a flexible disk (FD), a compact disk recordable (CD-R), or a digital versatile disk (DVD), and provided as a computer program product.

Moreover, a program executed in the device according to each of the first to third embodiments may be stored on a computer connected to a network such as the Internet and may be provided by downloading via the network. Also, a program executed in the device according to each of the first to third embodiments may be provided or distributed via a network such as the Internet.

A program executed in the device according to each of the first to third embodiments may cause a computer to function as each unit of the devices described above. In this computer, the CPU 51 can read a program from a computer-readable storage medium onto a primary storage device and perform execution thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning device comprising:
a calculator configured to calculate a value of a first objective function and a value of a second objective function, the first objective function including smoothness that indicates smoothness of a local distribution of an output of a model, the first objective function being used to estimate a first model parameter for determining the model, the second objective function being used to estimate, with a second model parameter that is a hyperparameter of a learning method of learning, the model by using the first objective function, the second model parameter to be estimated being closer to a distance scale of learning data; and
a learner configured to update the first model parameter and the second model parameter so that the value of the first objective function and the value of the second objective function are optimized.

2. The device according to claim 1, wherein the distance scale is a distance scale in a predetermined projective space.

3. The device according to claim 2, wherein
the model is a neutral network, and
the distance scale is a distance scale in a projective space indicating an output of an interlayer of the neutral network.

4. The device according to claim 1, wherein the distance scale is an average of a distance between each of a plurality of pieces of first learning data and second learning data that is a piece of learning data in which a distance from the piece of learning data to the first learning data is shorter than from other piece of learning data.

5. The device according to claim 1, wherein the distance scale is calculated for each piece of learning data.

6. The learning device according to claim 1, wherein the hyperparameter is for calculating the smoothness.

7. The learning device according to claim 1, wherein the model is a neutral network.

8. An information processing device comprising:
the learning device according to claim 1; and
a controller configured to control information processing using the model determined by the updated first model parameter.

9. A learning method comprising:
calculating a value of a first objective function and a value of a second objective function, the first objective function including smoothness that indicates smoothness of a local distribution of an output of a model, the first objective function being used to estimate a first model parameter for determining the model, the second objective function being used to estimate, with a second model parameter that is a hyperparameter of a learning method of learning, the model by using the first objective function, the second model parameter to be estimated being closer to a distance scale of learning data; and
updating the first model parameter and the second model parameter so that the value of the first objective function and the value of the second objective function are optimized.

10. A computer program product having a computer readable medium including programmed instructions, wherein the instructions, when executed by a computer, cause the computer to execute:
calculating a value of a first objective function and a value of a second objective function, the first objective function including smoothness that indicates smoothness of a local distribution of an output of a model, the first objective function being used to estimate a first model parameter for determining the model, the second objective function being used to estimate, with a second model parameter that is a hyperparameter of a learning method of learning, the model by using the first objective function, the second model parameter to be estimated being closer to a distance scale of learning data; and
updating the first model parameter and the second model parameter so that the value of the first objective function and the value of the second objective function are optimized.
